(19) United States
(12) Patent Application Publication
(10) Pub. No.: US 2015/0219817 A1
(43) Pub. Date: Aug. 6, 2015

(54) LIGHT GUIDE PANEL, RELATED BACKLIGHT UNIT, RELATED DISPLAY DEVICE, AND RELATED MANUFACTURING METHOD

(71) Applicant: Samsung Display Co., Ltd, Yongin-City (KR)

(72) Inventors: Hyoung Joo KIM, Anyang-si (KR); Rae Young KIM, Hwaseong-si (KR); Dong Yeon KANG, Seoul (KR); Min Young SONG, Asan-si (KR); Sung Kyu SHIM, Seoul (KR)

(21) Appl. No.: 14/299,431

(22) Filed: Jun. 9, 2014

(30) Foreign Application Priority Data
Feb. 3, 2014 (KR) 10-2014-0012161

(51) Int. Cl. F21V 8/00; G02F 1/1335; B29D 11/00; F21V 13/12

(52) U.S. Cl. CPC G02B 6/004; G02B 6/005; G02B 6/0045; F21V 13/12; G02F 1/1336; B29D 11/00663

(57) ABSTRACT

A light guide panel may include a first surface, a second surface overlapping the first surface, and a third surface oriented at an angle with respect to the second surface. The first surface may include a first face, a second face, a third face connected between the first face and the second face, and a first light-scattering structure positioned at a first portion of the second face. A distance between the first face and the second surface may be unequal to a distance between the second face and the second surface. The third face may not be parallel to the first face and may not be parallel to the second face.

### CROSS-REFERENCE TO RELATED APPLICATION

This application claims priority to Korean Patent Application No. 10-2014-0012161 filed on Feb. 3, 2014 in the Korean Intellectual Property Office, the disclosure of which is incorporated herein by reference in its entirety.

### BACKGROUND OF THE INVENTION

1. Field of the Invention

The present invention relates to a light guide panel (LGP), a backlight unit, a display device, and a method of manufacturing the LGP. The LGP may be an edge-illumination type LGP.

2. Description of the Related Art

A liquid crystal display (LCD) may include an LCD module connected to an external case. The LCD module may include a liquid crystal panel. The liquid crystal panel may include two substrates and a liquid crystal layer interposed between the two substrates. The LCD module may further include a backlight unit located behind the liquid crystal panel for supplying light to the liquid crystal layer. The liquid crystal panel may display an image by adjusting transmittance of light received from the backlight unit.

Backlight units are classified into direct-illumination type backlight units and edge-illumination type backlight units according to the position of a light source. In a direct-illumination type backlight unit, a light source is provided behind a display panel. An edge-illumination type backlight unit may include a light guide panel (LGP) for guiding light output from a light source toward a display panel. The LGP may guide the light toward the display panel by changing the path of the light.

### SUMMARY OF THE INVENTION

Embodiments of the present invention may advantageously enable substantial uniform luminance in a display device, such that substantially satisfactory image display quality may be provided.

Embodiments of the present invention may be related to a light guide panel (LGP) that may substantially uniformly provide light emitted from a light source unit to a display panel.

Embodiments of the present invention may be related to a backlight unit that can substantially optimize luminance uniformity of a display device.

Embodiments of the present invention may be related to a display device having substantially satisfactory luminance uniformity.

Embodiments of the present invention may be related to a method for manufacturing an LGP that may substantially uniformly provide light emitted from a light source unit to a display panel.

An embodiment of the invention may be related to a light guide panel that may include a first surface, a second surface overlapping the first surface, and a third surface oriented at an angle (e.g., 90 degrees) with respect to the second surface. The first surface may include a first face, a second face, a third face connected between the first face and the second face, and a first light-scattering structure positioned at a first portion of the second face. Each of the faces may represent a generally flat surface. A distance between the first face and the second surface may be unequal to a distance between the second face and the second surface. The third face may not be parallel to the first face and may not be parallel to the second face. Light transmittance of the first light-scattering structure may be different from light transmittance of a second portion of the second face.

Roughness of the first light-scattering structure may be greater than roughness of a second portion of the second face.

The first light-scattering structure may include lenses arranged along a boundary between the second face and the third face. Each of the lenses may extend perpendicular to the boundary.

The first light-scattering structure may include linear recess structures extending perpendicular to a boundary between the second face and the third face.

The first light-scattering structure may include recesses having different sizes and different shapes.

The first surface may include a second light-scattering structure positioned at a first portion of the third face. Light transmittance of the second light-scattering structure may be different from light transmittance of a second portion of the third face.

The second light-scattering structure may be directly connected to the first light-scattering structure.

The first portion of the second face may be directly connected to the third face.

The first portion of the second face may be disposed between a second portion of the second face and a boundary between the second face and the third face. No intended light-scattering structure may be provided at the second portion of the second face.

The first face may extend parallel to the second face,

The distance between the first face and the second surface may be greater than the distance between the second face and the second surface.

An area of the light-scattering structure in a plan view of the light guide panel may be greater than an area of the first face in the plan view of the light guide panel.

An area of the light-scattering structure in a plan view of the light guide panel may be greater than an area of the second face in the plan view of the light guide panel.

An embodiment of the present invention may be related to a backlight unit that may include a light source unit, a reflective sheet, an optical sheet, and a light guide panel disposed between the reflective sheet and the optical sheet. The light guide panel may include a first surface overlapping at least one of the reflective sheet and the optical sheet, a second surface overlapping the first surface, a third surface oriented at an angle with respect to the second surface and disposed adjacent to the light source unit. The first surface may include a first face, a second face, a third face connected between the first face and the second face, and a first light-scattering structure positioned at a first portion of the second face. A distance between the first face and the second surface may be unequal to a distance between the second face and the second surface. The third face may not be parallel to the first face and may not be parallel to the second face.

An embodiment of the present invention may be related to a display device that may include a light source unit, a light guide panel, and a display panel. The light guide panel may include a first surface, a second surface overlapping the first surface, a third surface oriented at an angle with respect to the second surface and disposed adjacent to the light source unit. The first surface may include a first face, a second face, a third face connected between the first face and the second face, and a first light-scattering structure positioned at a first portion of the second face. A distance between the first face and the second surface may be unequal to a distance between the second face and the second surface. The third face may not be parallel to the first face and may not be parallel to the second face. The display panel may overlap the light guide panel. The display panel may include a display area and a non-display area. The display area may be configured for displaying an image according to at least a control signal. The non-display area may abut the display area and may overlap the light-scattering structure.

A virtual geometric plane connecting and/or passing a boundary between the light-scattering structure and a second portion of the second face and a boundary between the display area and the non-display area may be at an acute angle with respect to the second face. The acute angle may have a size in a range of 40 to 50 degrees.

Light transmittance of the light-scattering structure may be different from light transmittance of a second portion (or a non-light-scattering portion) of the second face. The second portion of the second face may overlap the display area and may be spaced from the light-scattering structure.

An embodiment of the present invention may be related to a method for manufacturing a light guide panel. The method may include preparing an light guide panel material member that may include a first surface, a second surface overlapping the first surface, and a third surface oriented at an angle with respect to the second surface. The first surface may include a first face, a second face, and a third face connected between the first face and the second face. A distance between the first face and the second surface may be unequal to a distance between the second face and the second surface. The third face may not be parallel to the first face and may not be parallel to the second face. The method may further include rolling a structure-forming portion of a roller on the second face to form a light-scattering structure at the second face. The structure-forming portion may include protrusions and/or recesses. The method may further include accommodating the first face and the second face inside a recess structure of the roller when performing the rolling.

The rolling may include rotating the roller about an axis of the roller. A width of the structure-forming portion in a direction parallel to the axis of the roller may be less than a width of the second face in the direction.

An embodiment of the present invention may be related to a light guide panel that may include an upper surface, a lower surface that faces the upper surface, an incident surface disposed at a first side of the upper surface and the lower surface, and an opposite surface disposed on a second side of the upper surface and the lower surface to face the incident surface. The upper surface may include a first flat surface that extends from an upper end of the incident surface in a first direction, a first sloping surface that slopes downward from a second end of the first flat surface, and a second flat surface that extends from a lower end of the first sloping surface in the first direction. The second flat surface may include a pattern area (or light-scattering structure) that may extend a predetermined distance from the lower end of the first sloping surface in the first direction.

An embodiment of the present invention may be related to a backlight unit comprising an light guide panel, a light source unit disposed adjacent to a first side of the light guide panel, a reflective sheet disposed under the light guide panel, and an optical sheet disposed on the light guide panel, wherein the light guide panel may include one or more elements and structures described above. An embodiment of the present invention may be related to a display device that may include a backlight unit and a display panel overlapping and/or disposed on the backlight unit, wherein the backlight unit may include an light guide panel that may include one or more elements and structures described above, a light source unit disposed adjacent to a first side of the light guide panel, a reflective sheet disposed under the light guide panel, and an optical sheet disposed on the light guide panel.

### BRIEF DESCRIPTION OF THE DRAWINGS

FIG. 1 illustrates a perspective view of a light guide panel (LGP) according to an embodiment of the present invention.

FIG. 2 illustrates a side view of the LGP illustrated in FIG. 1.

FIG. 3 illustrates a plan view of an LGP according to an embodiment of the present invention.

FIG. 4 illustrates a cross-sectional view taken along the line I-I′ indicated in FIG. 3.

FIG. 5 illustrates a plan view of an LGP according to an embodiment of the present invention.

FIG. 6 illustrates an enlarged view of a portion “A” indicated in FIG. 5.

FIG. 7 illustrates a cross-sectional view taken along the line II-IF indicated in FIG. 6.

FIG. 8 illustrates a perspective view of an LGP according to an embodiment of the present invention.

FIG. 9 illustrates a plan view of the LGP illustrated in FIG. 8.

FIG. 10 illustrates a side view of some elements of a backlight unit according to an embodiment of the present invention.

FIG. 11 is a schematic view schematically illustrating the relationship between a display panel and an LGP of the backlight unit illustrated in FIG. 10.

FIG. 12 is a graph illustrating effects of embodiments of the present invention.

FIG. 13A and FIG. 13B show schematic diagrams illustrating effects of embodiments of the present invention.

FIG. 14 illustrates an exploded perspective view of a display device according to an embodiment of the present invention.

FIG. 15 illustrates an elevation view of elements related to manufacturing of an LGP for illustrating an operation of forming a pattern area on a flat surface of an LGP material member according to an embodiment of the present invention.

FIG. 16 illustrates a perspective view of elements related to manufacturing of an LGP for illustrating the operation of forming the pattern area on the flat surface of the LGP material member according to an embodiment of the present invention.

FIG. 17 illustrates an elevation view of elements related to manufacturing of an LGP for illustrating an operation of forming a pattern area on a flat surface of an LGP material member according to an embodiment of the present invention.

### DETAILED DESCRIPTION OF THE INVENTION

Advantages and features of the present invention will be apparent in view of the embodiments described in detail with reference to the accompanying drawings. The described embodiments are illustrative and are not limiting. The present invention is not limited to the described embodiments, but can be implemented in various forms.

In this application, the term “on” may mean “directly on” without intended intervening element and may mean “indirectly on” with one or more intervening elements.

In this application, same drawing reference numerals may be used for identical or analogous elements across various figures.

Although the terms “first”, “second”, etc. may be used herein to describe various elements, these elements, should not be limited by these terms. These terms may be used to distinguish one element from another element. Thus, a first element discussed below may be termed a second element without departing from the teachings of the present invention. The description of an element as a “first” element may not require or imply the presence of a second element or other elements. The terms “first”, “second”, etc. may also be used herein to differentiate different categories or sets of elements. For conciseness, the terms “first”, “second”, etc. may represent “first-category (or first-set)”, “second-category (or second-set)”, etc., respectively.

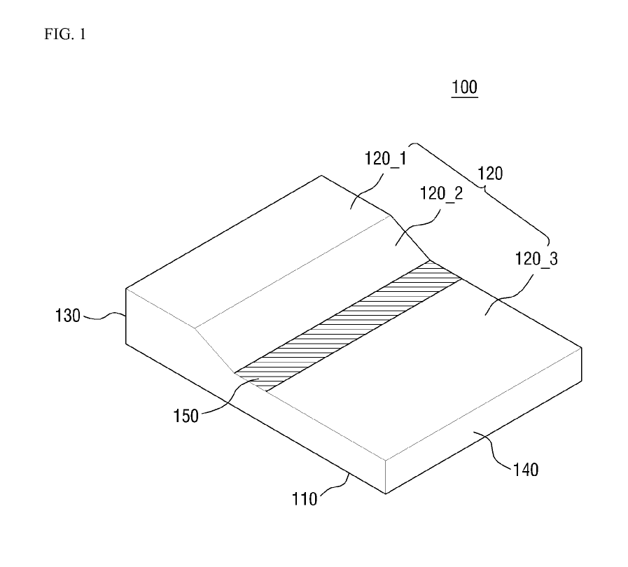

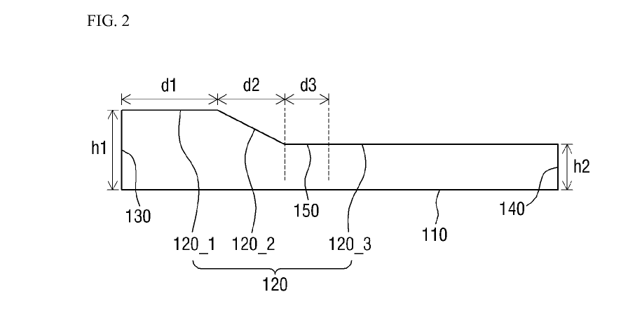

FIG. 1 illustrates a perspective view of a light guide panel (LGP) 100 according to an embodiment of the present invention. FIG. 2 illustrates a side view of the LGP 100 illustrated in FIG. 1.

Referring to FIGS. 1 and 2, the LGP 100 includes an upper surface 120 (or first surface 120), a lower surface 110 (or second surface 110) that overlaps and/or faces the upper surface 120, a light incident surface 130 (or incident surface 130) disposed at a first side of the upper surface 120 and the lower surface 110, and an opposite surface 140 disposed at a second side of the upper surface 120 and the lower surface 110 to face the incident surface 130. The upper surface 120 of the LGP 100 includes a first generally flat surface 120_1 (or first face 120_1) that extends from an upper end of the incident surface 130 in a first direction and is substantially parallel to the lower surface 110 and/or substantially perpendicular to the incident surface 130, a first sloping surface 120_2 (or third face 120_2) that slopes downward from a second end of the first flat surface 120_1 and is not parallel to the lower surface 110 and/or not perpendicular to the incident surface 130, and a second generally flat surface 120_3 (or second face 120_3) that extends from a lower end of the first sloping surface 120_2 in the first direction and is substantially parallel to the lower surface 110 and/or substantially perpendicular to the incident surface 130. The second flat surface 120_3 includes a pattern area 150 (or light-scattering structure 150) that extends a predetermined distance from the lower end of the first sloping surface 120_2 in the first direction. In solid geometry, a face is a generally flat (planar) surface that forms part of the boundary of a solid object.

The LGP 100 may be made of a transparent material. For example, the LGP 100 may be made of a material such as polycarbonate (PC) or polymethyl methacrylate (PMMA). In some embodiments, the LGP 100 may have flexibility. The flexibility of the LGP 100 may be related to a thickness, shape, material, etc. thereof.

The lower surface 110 of the LGP 100 faces the upper surface 120 of the LGP 100. A width of the lower surface 110 of the LGP 100 may be substantially equal to a maximum horizontal width of the upper surface 120 of the LGP 100 in the first direction.

The lower surface 110 of the LGP 100 may include a plurality of scattering patterns or elements. The scattering patterns or elements may have structures and/or structures of some conventional scattering patterns.

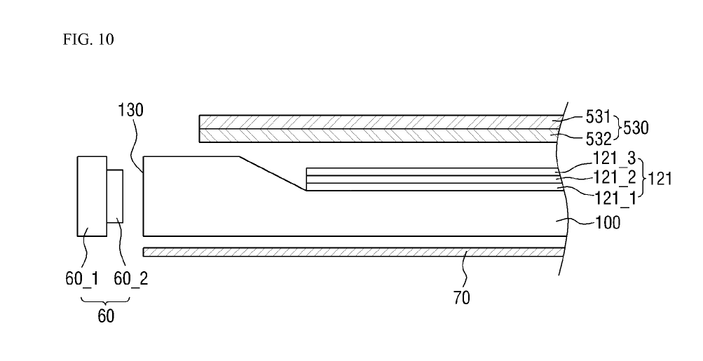

The incident surface 130 may be disposed at a first side surface of the LGP 100, and the opposite surface 140 may be disposed at a second side surface of the LGP 100. In an embodiment, a height h1 of the incident surface 130 may be different from a height h2 of the opposite surface 140. The height h1 of the incident surface 130 may be relatively greater than the height h2 of the opposite surface 140. This may be related to the size of a light source unit 60 (illustrated in FIG. 10) that irradiates light to the LGP 100. In some embodiment, even if the minimum thickness of the LGP 100 becomes thin, the light source unit 60, which irradiates light to the incident surface 130, may not become as thin as the minimum thickness of the LGP 100. Therefore, the height h1 of the incident surface 130 may be made to correspond to the size of the light source unit 60 and to be relatively greater than the height h2 of the opposite surface 140 in order to minimize light loss.

Accordingly, the upper surface 120 of the LGP 100 may include the first flat surface 120_1, the first sloping surface 120_2, and the second flat surface 120_3.

More specifically, the first flat surface 120_1 may extend in a horizontal direction from the incident surface 130 disposed at the first side surface of the LGP 100. In other words, the first flat surface 120_1 may extend from the upper end of the incident surface 130 toward a second side of the LGP 100, that is, may extend along the first direction. The first direction may be a direction perpendicular to the incident surface 130.

The first sloping surface 120_2 may slope a predetermined distance downward from the second end of the first flat surface 120_1. The second flat surface 120_3 may extend in the first direction from the lower end of the first sloping surface 120_2 to an upper end of the opposite surface 140, which faces the incident surface 130. That is, a second end of the second flat surface 120_3 and the upper end of the opposite surface 140 may contact each other.

The pattern area 150 may be formed on the second flat surface 120_3. In other words, the second flat surface 120_3 may include the pattern area 150 and a non-pattern area neighboring the pattern area 150.

The light transmittance of the pattern area 150 may be different from that of the non-pattern area. In an embodiment, the light transmittance of the pattern area 150 may be relatively lower than that of the non-pattern area. Light irradiated to the pattern area 150 may be scattered or reflected toward the lower surface 110.

In an embodiment, the roughness of the pattern area 150 may be different from that of the non-pattern area. The roughness of the pattern area 150 may be greater than that of the non-pattern area.

The pattern area 150 may extend a predetermined distance from the lower end of the first sloping surface 120_1 along the first direction. In an embodiment, a width d3 of the pattern area 150 may be greater than a width d1 of the first flat surface 120_1 and a horizontal width d2 of the first sloping surface 120_2. An area of the pattern area 150 in a plan view of the LGP 100 may be greater than an area of the first flat surface 120_1 in the plan view of the LGP 100. An area of the pattern area 150 in a plan view of the LGP 100 may be greater than an area of the first sloping surface 120_2 in the plan view of the LGP 100.

In an embodiment, the width d1 of the first flat surface 120_1 may be, but is not limited to, substantially equal to the horizontal width d2 of the first sloping surface 120_2 in the first direction.

For example, the width d1 of the first flat surface 120_1 and the horizontal width d2 of the first sloping surface 120_2 in the first direction may be approximately 1 mm, and the width d3 of the pattern area 150 may be 2 to 5 mm. In some embodiments, the width d1 of the first flat surface 120_1, the horizontal width d2 of the first sloping surface 120_2, and the width d3 of the pattern area 150 are not limited to this example.

In an embodiment, a plurality of scattering patterns and/or structures may be formed at the pattern area 150. The scattering patterns and/or structures may include one or more recesses and one or more protrusions. The scattering patterns and/or structures may include uneven surface structures.

The scattering patterns and/or structures formed on the pattern area 150 may scatter light irradiated to the pattern area 150. Accordingly, it is possible to prevent the concentration of light, thereby improving the luminance uniformity of a display device.

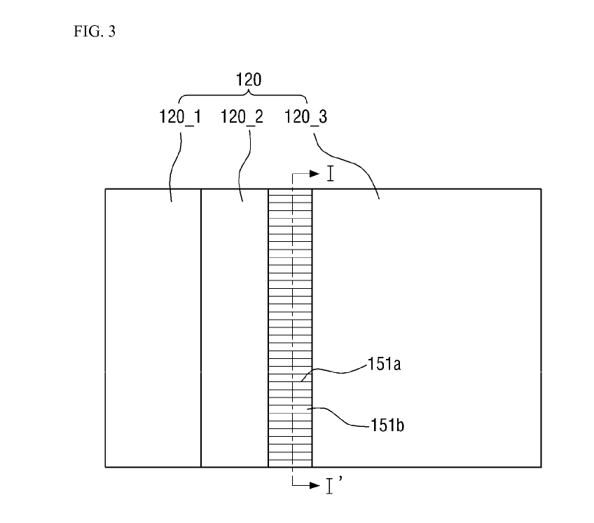

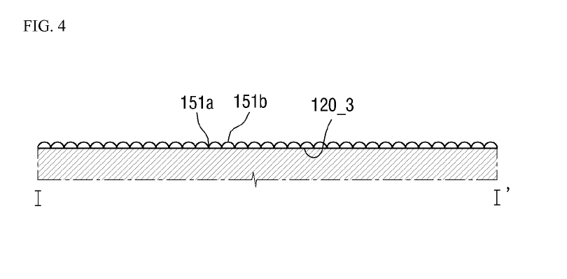

FIG. 3 illustrates a plan view of an LGP according to an embodiment of the present invention. FIG. 4 illustrates a cross-sectional view taken along the line I-I′ indicated in FIG. 3.

Referring to FIGS. 3 and 4, a plurality of substantially linear structures extending in a first direction perpendicular to the light incident surface are formed at the pattern area 150 (illustrated in FIGS. 1 and 2).

The linear structures may be disposed on at pattern area 150. The linear structure may be arranged along a second direction perpendicular to the first direction, and each of the linear structures may extend in the first direction. A first end of each of the linear structures may contact (and/or be positioned at) a first end of the pattern area 150, and a second end of each of the linear structures may contact (and/or be positioned at) a second end of the pattern area 150.

The linear structures may include relatively recessed linear structures 151a and relatively protruding linear structures 151b (or lenses 151b). Each recessed linear structure 151a may be positioned between two immediately adjacent protruding linear structures 151b.

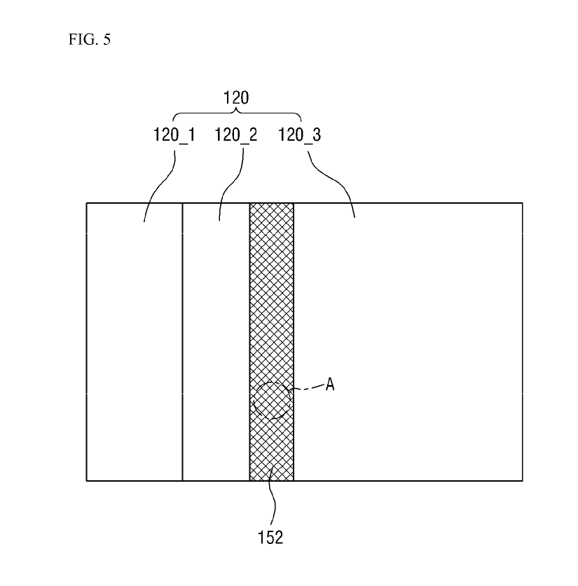

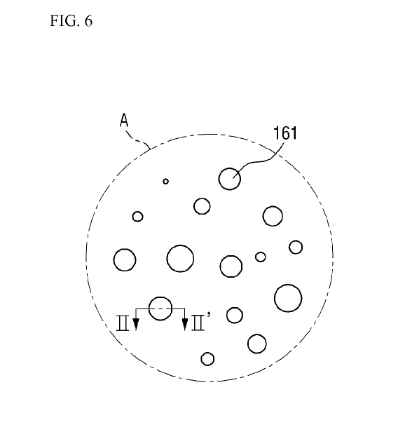

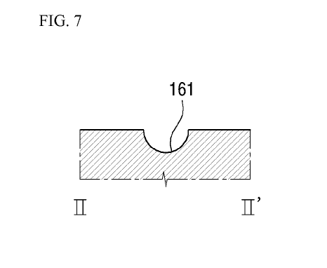

FIG. 5 illustrates a plan view of an LGP according to an embodiment of the present invention. FIG. 6 illustrates an enlarged view of a portion “A” indicated in FIG. 5. FIG. 7 is a cross-sectional view taken along the line II-IF indicated in FIG. 6.

Referring to FIGS. 5 through 7, a sandblasted surface 152 may be formed at the pattern area 150 (illustrated in FIGS. 1 and 2) of the LGP. The sandblasted surface 151 may include a plurality of recesses 161 having irregular and/or different sizes and/or shapes.

The recesses 161 may scatter irregularly at the pattern area. Each of the recesses 161 may be recessed with respect to the second flat surface 120_3.

In an embodiment, a mixture of protrusions and recesses may be formed at the pattern area 150.

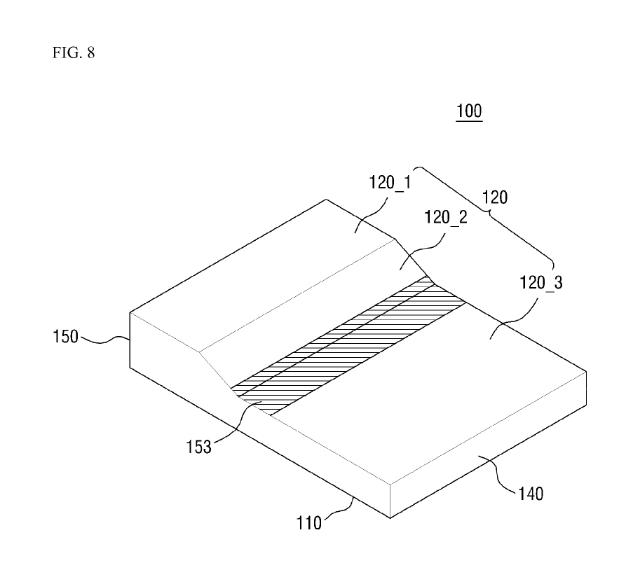

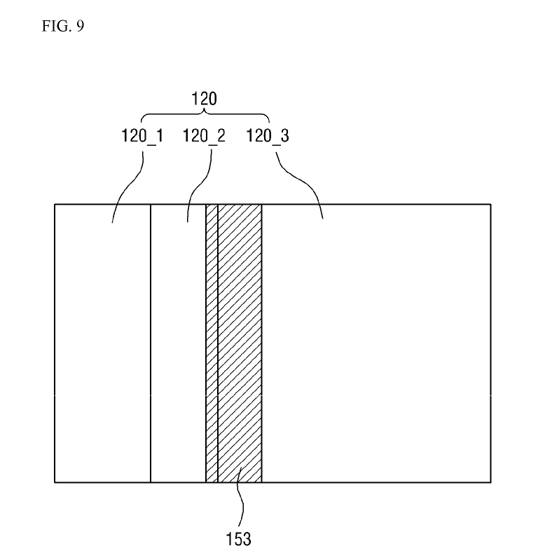

FIG. 8 illustrates a perspective view of an LGP according to an embodiment of the present invention. FIG. 9 illustrates a plan view of the LGP illustrated in FIG. 8.

Referring to FIGS. 8 and 9, a first end of a pattern area 153 of the LGP extends a predetermined distance along the first sloping surface 120_2.

The pattern area 153 may include a first portion formed at part of the first sloping surface 120_2 and may include a second portion formed at part of the second flat surface 120_3. Specifically, the pattern area 153 may extend a predetermined distance in a first direction from a lower end of the first sloping surface 120_2 and extend a predetermined distance from the lower end of the first sloping surface 120_2 toward an upper end of the first sloping surface 120_2.

The pattern area 153 extending to part of the first sloping surface 120_2 can mitigate concentration of light emitted from a light source unit 60, thereby improving luminance uniformity of a display device.

The first portion and/or the second portion of the pattern area 153 may include one or more of light-scattering structures discussed with reference to one or more of FIGS. 1 to 7.

FIG. 10 illustrates a side view of some elements of a backlight unit according to an embodiment of the present invention.

Referring to FIG. 10, the backlight unit a may include an LGP 100, a light source unit 60 disposed adjacent to a first side (or light incident side) of the LGP 100, a reflective sheet 70 overlapping and/or disposed under the LGP 100, and one or more optical sheets 121 overlapping and/or disposed on the LGP 100. As illustrated in one or more of FIGS. 1 to 9, the LGP 100 includes an upper surface 120, a lower surface 110 that faces the upper surface 120, an incident surface 130 disposed at a first side of the upper surface 120 and the lower surface 110, and an opposite surface disposed at a second side of the upper surface 120 and the lower surface 110 to face the incident surface 130. The upper surface 120 of the LGP 100 includes a first flat surface that extends from an upper end of the incident surface 130 in a first direction, a first sloping surface that slopes downward from a second end of the first flat surface, and a second flat surface 1203 that extends from a lower end of the first sloping surface in the first direction. The second flat surface 120_3 includes a pattern area 150 that extends a predetermined distance from the lower end of the first sloping surface in the first direction. Alternatively or additionally, the LGP 100 may include the pattern area 153 discussed with reference to FIGS. 8 and 9.

The LGP 100 may include elements and/or structures that may be identical and/or analogous to elements and/or structures of one or more of the LGPs discussed with reference to FIGS. 1 to 9.

The light source unit 60 may be disposed at the first side of the LGP 100. Specifically, the light source unit 60 may be adjacent to and/or contact the incident surface 130 of the LGP 100. The light source unit 60 may include a body portion 60_1 and a light-emitting portion 602 disposed on the body portion 60_1. The light-emitting portion 60_2 may include one or more of a light-emitting diode (LED), a cold cathode fluorescent lamp (CCFL), and an organic light-emitting diode.

The reflective sheet 70 may be disposed under the LGP 100. The reflective sheet 70 may reflect light leaked from the lower surface 110 of the LPG 100 toward the upper surface 120 of the LGP 100. The reflective sheet 70 may reflect light that has not been reflected by the lower surface 110 of the LGP toward the upper surface 120 of the LGP 100, thereby reducing light loss.

The reflective sheet 70 may have a single layer structure or a stacked structure of at least two layers.

The reflective sheet 70 may be made of polyethylene terephthalate (PET) with reflectivity. A surface of the reflective sheet 70 may be coated with a diffusion layer that contains titanium dioxide.

The reflective sheet 70 may at least partially overlap the lower surface 110 of the LGP 100. In an embodiment, the reflective sheet 70 may overlap at least a portion of the lower surface 110 of the LGP 100 that corresponds to (and/or overlaps) the second flat surface 120_3 of the upper surface 120 of the LGP 100.

The optical sheets 121 may include one or more sheets. In an embodiment, the optical sheets 121 may include a diffusion sheet 121_1, a luminance enhancement sheet 121_2, and a reflective polarizing sheet 121_3. The optical sheets 121 may be disposed on the LGP 100 to increase the efficiency of light output from the LGP 100 and to enhance uniformity of the luminance distribution of the light.

The diffusion sheet 121_1 may direct light incident from the LGP 100 toward a surface of a display panel 530 and may diffuse light to enable substantially uniform distribution of the light over a wide area before providing the light to the display panel 530. The diffusion sheet 121_1 may include a transparent resin film and a predetermined light diffusing member coated on each surface of the transparent resin film that overlaps the display panel 530.

The luminance enhancement sheet 121_2 may refract light obliquely incident thereupon to be refracted light that is perpendicular to a light incident surface of the display panel 530, for improving light efficiency.

The reflective polarizing sheet 121_3 may transmit light parallel to its transmission axis and may reflect light perpendicular to the transmission axis. The direction of the transmission axis of the reflective polarizing sheet 121_3 may be consistent with and/or parallel to the direction of a polarization axis of the luminance enhancement sheet 121_2, in order to increase transmission efficiency.

The display panel 530 may overlap and/or be disposed on the optical sheets 121. The display panel 530 may include a first substrate 531, a second substrate 532 that overlaps the first substrate 531, and a liquid crystal layer disposed between the substrates.

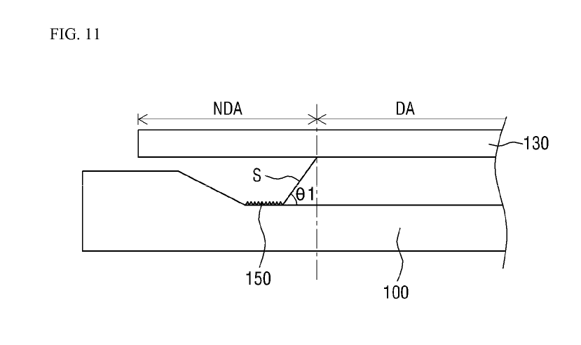

FIG. 11 is a schematic view schematically illustrating the relationship between the display panel 530 and the LGP 100 of the backlight unit illustrated in FIG. 10.

Referring to FIG. 11, a first angle θ1 may be defined by a geometric virtual surface S, which connects a first end of a display area DA of the display panel 530 and a second end of the pattern area 150, and the second flat surface 120_3.

The display panel 530 may include the display area DA and a non-display area NDA. The display area DA is where an image is to be displayed, and an image displayed on the display area DA is visible to a user.

The non-display area NDA may be disposed along an outer circumference of the display area DA. The non-display area NDA may include a driver that drives the display area DA and a circuit board that transmits and receives various signals for controlling an image that is to be displayed on the display area DA. The display area DA and the non-display area NDA may include some elements and/or structures substantially identical to and/or analogous to some elements and/or structures of a display area DA and a non-display area NDA of a conventional display panel.

In an embodiment, the pattern area 150 may overlap the non-display area NDA.

The virtual surface S may connect the second end of the pattern area 150 and the first end of the display area DA. The virtual surface S may form the first angle θ1 with the second flat surface 120_3. In an embodiment, the first angle θ1 may be in a range of 40 degrees to 50 degrees; advantageously, even if light is concentrated in the non-display area NDA, it cannot be substantially seen by a user. Therefore, the luminance uniformity and display quality of the display area DA of the display device can be improved.

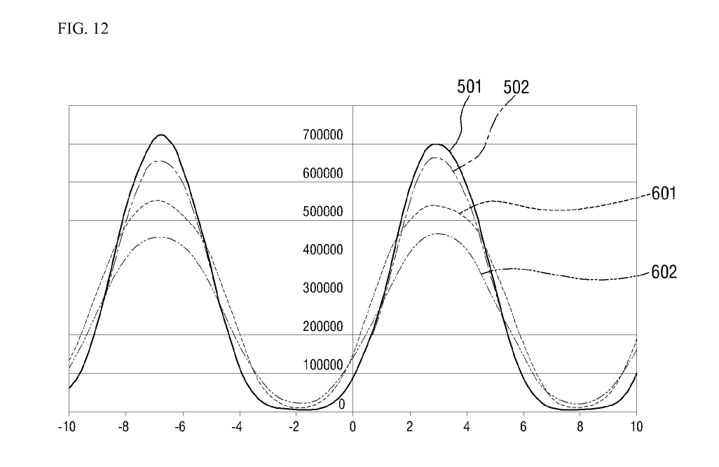

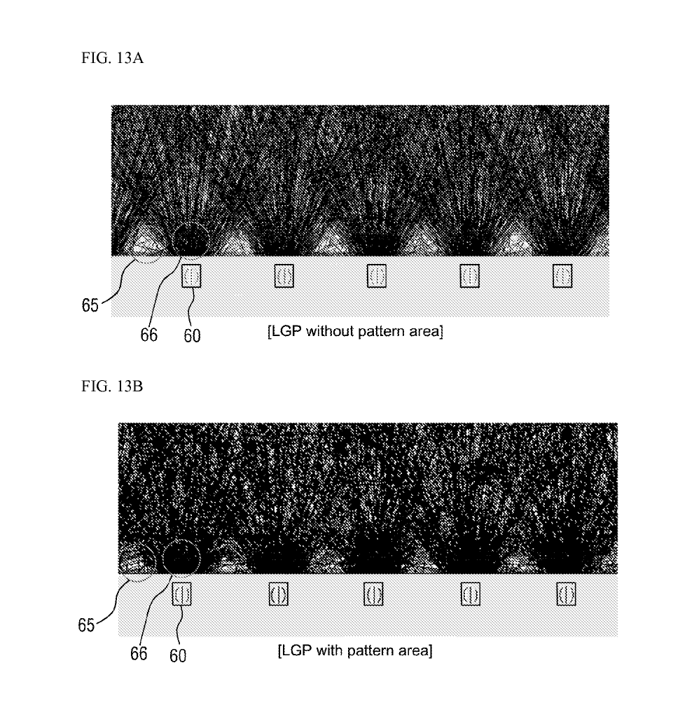

FIG. 12 is a graph illustrating effects of embodiments of the present invention. FIG. 13A and FIG. 13B show schematic diagrams that illustrating effects of embodiments of the present invention.

Referring to FIGS. 13A and 13B, bright portions 66 receiving a high concentration of light and dark portions 65 receiving a low concentration of light may be formed in an LGP 100 as a result of light provided by a plurality of light source units 60 separated from each other. The bright portions 66 and the dark portions 65 may affect display quality. As the difference in luminous intensity between the bright portions 66 and the dark portions 65 decreases, display quality may improve.

The x axis of FIG. 12 represents distance in an LGP along a second direction parallel to the incident surface 130 and perpendicular to the first direction that is perpendicular to the incident surface 130, and they axis of FIG. 12 represents luminous intensity.

Referring to FIG. 12, the first line 501 and the second line 502 represent light characteristics of conventional LGPs without the pattern area 150, and the third line 601 and the fourth line 602 represent light characteristics of LGPs with the pattern area 150. The third line 601 may represent an embodiment in which the width d3 of a pattern area 150 (indicated in FIG. 2) in the first direction is 3 mm, and the fourth line 602 may represent an embodiment in which the width d3 of the pattern area 150 is 4 mm.

Peaks of each line shown in FIG. 12 may indicate bright portions 66 indicated in FIG. 13A or FIG. 13B, and valleys of each line shown in FIG. 12 may indicate dark portions 65 indicated in FIG. 13A or FIG. 13B.

Referring to the graph of FIG. 12, the difference in luminous intensity between the bright portions 66 and the dark portions 65 is smaller when the pattern area 150 is disposed on an upper surface of an LGP according to embodiments of the invention than when otherwise. The effects can also be confirmed in FIG. 13A and FIG. 13B. FIG. 13A illustrates light distribution in a conventional LGP without a pattern area 150. FIG. 13B illustrates light distribution in an LGP with a pattern area according to an embodiment of the invention. Referring to FIG. 13A and FIG. 13B, a display device having the pattern area 150 exhibits improved luminance uniformity.

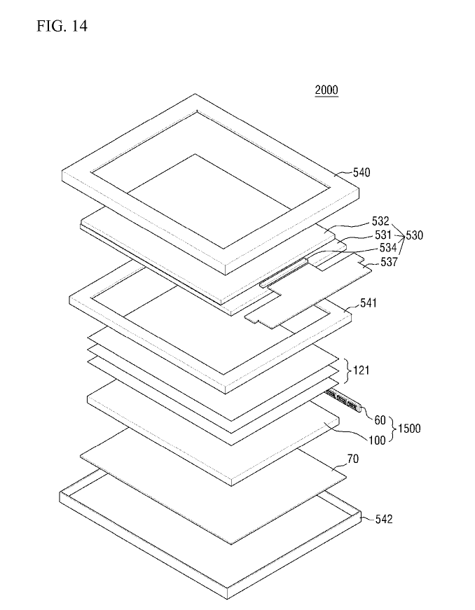

FIG. 14 illustrates an exploded perspective view of a display device 2000 according to an embodiment of the present invention.

Referring to FIG. 14, the display device 2000 includes a backlight unit 1500 and a display panel 530 disposed on the backlight unit 1500. The backlight unit 1500 includes an LGP 100, a light source unit 60 disposed adjacent to a first side of the LGP 100, a reflective sheet 70 disposed under the LGP 100, and one or more optical sheets 121 disposed on the LGP 100. The LGP 100 includes an upper surface, a lower surface that faces the upper surface, an incident surface that is disposed on a first side of the upper surface and the lower surface, and an opposite surface that is disposed on a second side of the upper surface and the lower surface to face the incident surface. The upper surface of the LGP 100 includes a first flat surface that extends from an upper end of the incident surface in a first direction, a first sloping surface that slopes downward from a second end of the first flat surface, and a second flat surface that extends from a lower end of the first sloping surface in the first direction. The second flat surface includes a pattern area that extends a predetermined distance from the lower end of the first sloping surface in the first direction.

The backlight unit 1500 and the LGP 100 may have elements and/or structures that are analogous to or identical to one or more elements and/or structures discussed with reference to one or more of FIGS. 1 to 11.

Referring to FIG. 14, the display device 2000 may further include the display panel 530, a top chassis 540, and a bottom chassis 542.

Specifically, the display panel 530 includes a display area DA and a non-display area NDA. The display panel 530 may include a first substrate 531, a second substrate 532 that faces the first substrate 531, a liquid crystal layer, and a driver 534 and a flexible circuit board 537 that are attached to at least one of the first substrate 531 and the second substrate 532. The display area DA of the display panel 530 may be where an image is to be displayed, and the non-display area NDA of the display panel 530 may be where no image is displayed. In a plan view of the display panel 530, the display area DA of the display panel 530 may be located in substantially the middle of an overlap area between the first substrate 531 and the second substrate 532, and the non-display area NDA of the display panel 530 may be located on the periphery of the overlap area between the first substrate 531 and the second substrate 532. The display area DA may be where the display panel 530 and the top chassis 540 do not overlap each other, and the non-display area NDA may be where the display panel 530 and the top chassis 50 overlap each other. In the plan view of the display panel 530, the display area DA of the display panel 530 may have a shape similar to the shape of at least one of the first substrate 531 and the second substrate 532 but may have a smaller area than the area of the second substrate 532. In the plan view of the display panel 530, boundaries of the display area DA and the non-display area NDA of the display panel 530 may be parallel to sides of at least one of the first substrate 531 and the second substrate 532 that face the boundaries, respectively, and a shape formed by the boundaries of the display area DA and the non-display area NDA may be a quadrilateral.

At least part of the first substrate 531 may overlap the second substrate 532. The middle of the overlap area between the first substrate 531 and the second substrate 532 may be the display area DA, and the periphery of the overlap area between the first substrate 531 and the second substrate 532 may be the non-display area NDA. The driver 534 and the flexible circuit board 537 may be attached to an area where the first substrate 531 and the second substrate 532 do not overlap each other.

The second substrate 532 may face the first substrate 531. The liquid crystal layer may be interposed between the first substrate 531 and the second substrate 532. A sealing member such as a sealant may be disposed between the first substrate 531 and the second substrate 532 along the periphery of the first substrate 531 and the second substrate 532 to bond the first substrate 531 and the second substrate 532 together and/or to seal the liquid crystal layer.

The first substrate 531 and the second substrate 532 may be shaped like rectangular parallelepipeds. For ease of description, the first substrate 531 and the second substrate 532 shaped like rectangular parallelepipeds are illustrated. However, the shapes of the first substrate 531 and the second substrate 532 are not limited to the rectangular parallelepipeds and may vary according to the shape of the display panel 530.

The driver 534 may transmit various signals (such a driving signal) required to display an image on the display area DA. The flexible circuit board 537 may output various signals to the driver 534.

The backlight unit 1500 may be disposed on a second surface of the display panel 530. The backlight unit 1500 may include the light source unit 60 that emits light and the LGP 100 that guides light emitted from the light source unit 60. The display device 2000 may include the reflective sheet 70 that is disposed under the LGP 100 and configured to change the path of light travelling downward from the LGP 100, the optical sheets 121 that are disposed on the LGP 100 and configured to modify optical characteristics of emitted light, and a mold frame 541 that houses the above elements.

The mold frame 541 may support and fix the display panel 530 by contacting the periphery of the second surface of the display panel 530. In an embodiment, the periphery of the second surface of the display panel 530 may be the non-display area NDA of the display panel 530. That is, at least part of the mold frame 541 may overlap the non-display area NDA of the display panel 530.

The top chassis 540 may cover edges and side surfaces of the display panel 530 and side surfaces of the light source unit 60. The bottom chassis 542 may house the optical sheets 121, the LGP 100, the backlight unit 1500, and the reflective sheet 70. The top chassis 540 and the bottom chassis 542 may be made of a heat and/or electricity conductive material such as metal.

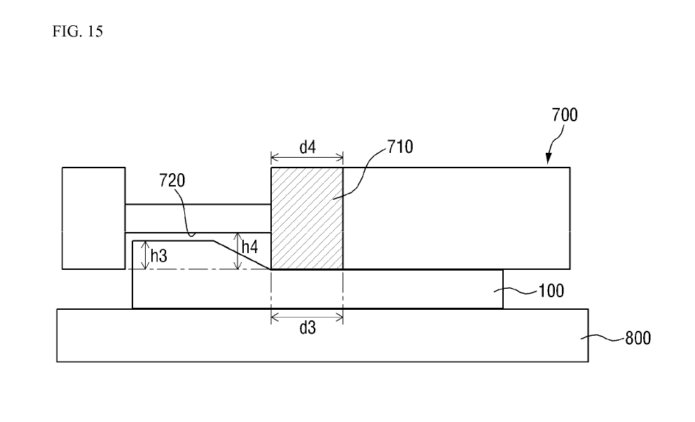

Methods of manufacturing an LGP according to embodiments of the present invention will are described with reference to FIGS. 15 to 17.

A method of manufacturing an LGP according to an embodiment includes preparing an LGP material member whose upper surface includes a first flat surface that extends along a first direction, a first sloping surface that slopes downward from a second end of the first flat surface, and a second flat surface that extends from a second end of the first sloping surface along the first direction; putting the LGP material member between a first roller and a support roller that is placed to face the first roller; and forming a pattern area on the second flat surface. The first roller includes a recessed portion that corresponds to the first flat surface and the first sloping surface, and the first roller includes a pattern forming portion that corresponds to a portion of the second flat surface adjacent to the second (lower) end of the first sloping surface.

Specifically, an LGP 100 is prepared. An upper surface of the LGP material member includes a first flat surface 120_1 that extends along the first direction, a first sloping surface 120_2 that slopes downward from a second end of the first flat surface 120_1, and a second flat surface 120_3 that extends from a second end of the first sloping surface 120_2 along the first direction.

The LGP 100 may have elements and/or structures that are substantially identical to and/or analogous to some elements and/or structures discussed with reference to one or more of FIGS. 1 to 14.

The LGP 100 may include a protruding portion that protrudes from the second flat surface 120_3. The protruding portion of the LGP 100 may include the first sloping surface 120_2 and the first flat surface 120_1.

A pattern area 150 is formed on the second flat surface 120_3 by putting an LGP material member between a first roller 700 and a support member 800 that is placed to face the first roller 700.

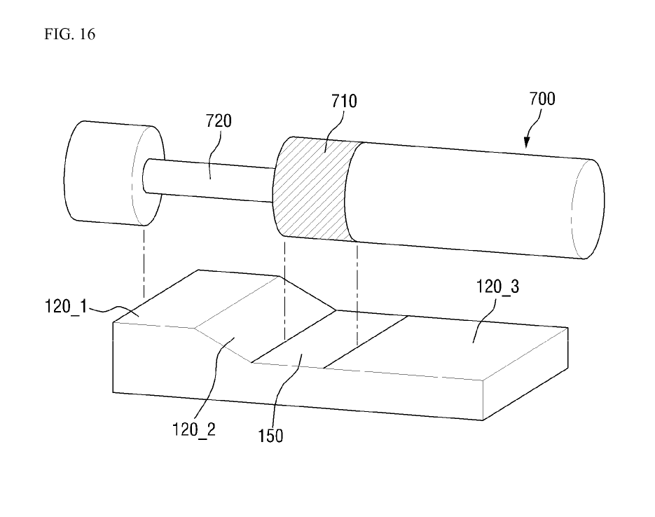

The first roller 700 and the support member 800 are further described with reference to FIGS. 15 and 16.

FIG. 15 and FIG. 16 illustrate a side view and a perspective view, respectively, of elements related to manufacturing of an LGP for illustrating a process of forming the pattern area 150 on the second flat surface 120_3 according to an embodiment of the present invention. In the process, the LGP 100 may be disposed between the first roller 700 and the support member 800, which faces the first roller 700.

The first roller 700 may include a recessed portion 720 (or recess structure 720). The recessed portion 720 of the first roller 700 may be formed to correspond to the protruding portion of the LGP 100. The recessed portion 720 may be formed large enough to fully accommodate the protruding portion. That is, the size of the recessed portion 720 may be substantially equal to or greater than the size of the protruding portion. In an embodiment, a depth h4 of the recessed portion 720 may be substantially equal to or greater than a protruding length (or height) h3 of the protruding portion. In an embodiment, a cross-sectional shape of the recessed portion 720 may be a quadrilateral.

The recessed portion 720 is large enough to fully accommodate the protruding portion, such that the first roller 700 may sufficiently contact the second flat surface 120_3.

The pattern (and/or structure) forming portion 710 may be disposed adjacent to the recessed portion 720. The pattern forming portion 710 may form the pattern area 150 on the second flat surface 120_3. The position of the pattern forming portion 710 may correspond to a position at which the pattern area 150 is to be formed. In an embodiment, a first end of the pattern forming portion 710 may be placed adjacent to the second end of the first sloping surface 120_2.

To form the pattern area 150, the pattern forming portion 710 may include patterns and/or structures corresponding to various patterns and/or structures that are to be formed on the pattern area 150. In an embodiment, a width d4 of the pattern forming portion 710 may be substantially equal to a width d3 of the pattern area 150 in the first direction substantially perpendicular to the incident surface 130 and/or substantially parallel to the lower surface 110 (illustrated in FIG. 2).

The support member 800 may have a flat principal plane. The support member 800 may support the LGP 100, specifically, a lower surface of the LGP 100. The LGP 100 may be supported by the support member 800, and the first roller 700 may move while applying pressure to the upper surface of the LGP 100, thereby forming the pattern area 150 on the second flat surface 120_3 of the LGP 100.

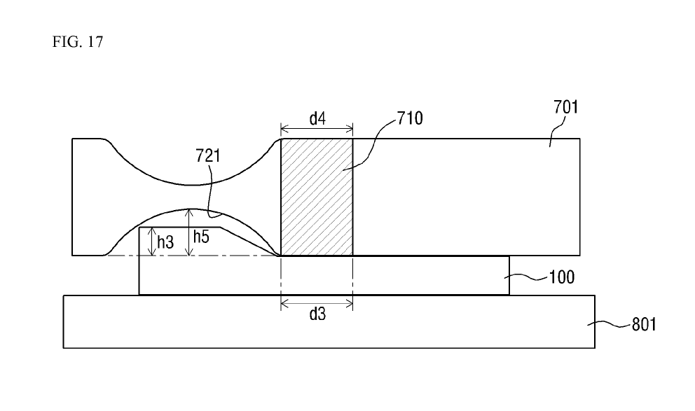

FIG. 17 illustrates an elevation view of elements related to manufacturing of an LGP for illustrating an operation of forming a pattern area on a flat surface of an LGP material member according to an embodiment of the present invention.

Referring to FIG. 17, a first roller 701 may have elements and/or structures that are substantially identical to and/or analogous to some elements and/or structures of the first roller 700 discussed with reference to FIG. 16. In an embodiment, a cross-section of a recessed portion 721 (or recess structure 721) of the first roller 701 is arc-shaped or shaped like a gentle arc.

The first roller 700 illustrated in FIG. 16 can be replaced by the first roller 701 illustrated in FIG. 17 in a process of forming the pattern area 150.

The cross-section of the recessed portion 721 of the first roller 701 may be shaped like a gentle arc. That is, the recessed portion 721 may include a curved surface recessed from the rolling plane. A maximum depth h5 of the recessed portion 721 may be greater than the height h3 of the protruding portion of the LGP 100. The recessed portion 721 having the curved surface can reduce the pressure applied to the protruding portion of the LGP 100.

Embodiments of the present invention may advantageously optimize luminance uniformity of a display device, such that satisfactory image display quality may be provided.

While this invention has been described in terms of several embodiments, there are alterations, permutations, and equivalents, which fall within the scope of this invention. It should also be noted that there are many alternative ways of implementing the methods and apparatuses of the present invention. Furthermore, embodiments of the present invention may find utility in other applications. The abstract section is provided herein for convenience and, due to word count limitation, is accordingly written for reading convenience and should not be employed to limit the scope of the claims. It is therefore intended that the following appended claims be interpreted as including all such alterations, permutations, and equivalents as fall within the true spirit and scope of the present invention.

What is claimed is:

1. A light guide panel comprising:
a first surface;
a second surface overlapping the first surface; and
a third surface oriented at an angle with respect to the second surface,
wherein the first surface comprises a first face, a second face, a third face connected between the first face and the second face, and a first light-scattering structure positioned at a first portion of the second face,
wherein a distance between the first face and the second surface is unequal to a distance between the second face and the second surface, and
wherein the third face is not parallel to the first face and is not parallel to the second face.

2. The light guide panel of claim 1, wherein light transmittance of the first light-scattering structure is different from light transmittance of a second portion of the second face.

3. The light guide panel of claim 1, wherein roughness of the first light-scattering structure is relatively than roughness of a second portion of the second face.

4. The light guide panel of claim 1, wherein the first light-scattering structure comprises lenses arranged along a boundary between the second face and the third face, and wherein each of the lenses extends perpendicular to the boundary.

5. The light guide panel of claim 1, wherein the first light-scattering structure comprises linear recess structures extending perpendicular to a boundary between the second face and the third face.

6. The light guide panel of claim 1, wherein the first light-scattering structure comprises recesses having different sizes and different shapes.

7. The light guide panel of claim 1, wherein the first surface further comprises a second light-scattering structure positioned at a first portion of the third face, and wherein light transmittance of the second light-scattering structure is different from light transmittance of a second portion of the third face.

8. The light guide panel of claim 7, wherein the second light-scattering structure is directly connected to the first light-scattering structure.

9. The light guide panel of claim 1, wherein the first portion of the second face is directly connected to the third face.

10. The light guide panel of claim 1, wherein the first portion of the second face is disposed between a second portion of the second face and a boundary between the second face and the third face, and wherein no intended light-scattering structure is provided at the second portion of the second face.

11. The light guide panel of claim 1, wherein the first face extends parallel to the second face,

12. The light guide panel of claim 1, wherein the distance between the first face and the second surface is greater than the distance between the second face and the second surface.

13. The light guide panel of claim 1, wherein an area of the light-scattering structure in a plan view of the light guide panel is greater than an area of the first face in the plan view of the light guide panel.

14. The light guide panel of claim 1, wherein an area of the light-scattering structure in a plan view of the light guide panel is greater than an area of the second face in the plan view of the light guide panel.

15. A backlight unit comprising:
a light source unit;
a reflective sheet;
an optical sheet; and
a light guide panel disposed between the reflective sheet and the optical sheet and comprising a first surface overlapping at least one of the reflective sheet and the optical sheet, a second surface overlapping the first surface, a third surface oriented at an angle with respect to the second surface and disposed adjacent to the light source unit, wherein the first surface comprises a first face, a second face, a third face connected between the first face and the second face, and a first light-scattering structure positioned at a first portion of the second face, wherein a distance between the first face and the second surface is unequal to a distance between the second face and the second surface, and wherein the third face is not parallel to the first face and is not parallel to the second face.

16. A display device comprising:
a light source unit;
a light guide panel that comprises a first surface, a second surface overlapping the first surface, a third surface oriented at an angle with respect to the second surface and disposed adjacent to the light source unit, wherein the first surface comprises a first face, a second face, a third face connected between the first face and the second face, and a first light-scattering structure positioned at a first portion of the second face, wherein a distance between the first face and the second surface is unequal to a distance between the second face and the second surface, and wherein the third face is not parallel to the first face and is not parallel to the second face; and
a display panel overlapping the light guide panel, wherein the display panel comprises a display area and a non-display area, wherein the display area is configured for displaying an image according to at least a control signal, and wherein the non-display area abuts the display area and overlaps the light-scattering structure.

17. The display device of claim 16, wherein a virtual plane connecting a boundary between the light-scattering structure and a second portion of the second face and a boundary between the display area and the non-display area is at an acute angle with respect to the second face, and wherein the acute angle has a size in a range of 40 to 50 degrees.

18. The display device of claim 16, wherein light transmittance of the light-scattering structure is different from light transmittance of a second portion of the second face, and wherein the second portion of the second face overlaps the display area and is spaced from the light-scattering structure.

19. A method for manufacturing a light guide panel, the method comprising:
preparing an light guide panel material member that comprises a first surface, a second surface overlapping the first surface, and a third surface oriented at an angle with respect to the second surface, wherein the first surface comprises a first face, a second face, and a third face connected between the first face and the second face, wherein a distance between the first face and the second surface is unequal to a distance between the second face and the second surface, and wherein the third face is not parallel to the first face and is not parallel to the second face;
rolling a structure-forming portion of a roller on the second face to form a light-scattering structure at the second face; and
accommodating the first face and the second face inside a recess structure of the roller when performing the rolling.

20. The method of claim 19, wherein the rolling may comprise rotating the roller about an axis of the roller, and wherein a width of the structure-forming portion in a direction parallel to the axis of the roller is less than a width of the second face in the direction.
